(19) United States
(12) Patent Application Publication
(10) Pub. No.: US 2017/0093594 A1
(43) Pub. Date: Mar. 30, 2017

(54) SMART HOME SYSTEM ADAPTED TO INDOOR AND OUTDOOR ENVIRONMENTAL CHANGES

(71) Applicant: DEAWANG SYSTEM CO., LTD., Daegu (KR)

(72) Inventor: In Gi PEAK, Seoul (KR)

(21) Appl. No.: 15/172,179

(22) Filed: Jun. 3, 2016

(30) Foreign Application Priority Data
Apr. 3, 2015 (KR) 10-2015-0047717
Feb. 25, 2016 (KR) 10-2016-0022590

(51) Int. Cl. H04L 12/28; G08B 17/10; G05B 15/02; H04W 84/18

(52) U.S. Cl. CPC H04L 12/2816; H04W 84/18; G08B 17/10; G05B 15/02

(57) ABSTRACT

The present disclosure provides a smart home system including an outdoor environment sensing sub-system and an indoor environment sensing sub-system detecting outdoor and indoor environmental factors respectively and a controller to analyze the detected factors and to vary indoor environmental reference data based on the analysis, and to control indoor home facilities based on the varied reference data so as to reach optimal indoor environmental factors.

### CROSS-REFERENCE TO RELATED APPLICATION

This application claims the benefit of Korea Patent Application No. 10-2016-0022590 filed on Feb. 25, 2016, which claims the benefit of Korea Patent Application No. 10-2015-0047717 filed on Apr. 3, 2015, the entire contents of which are incorporated herein by reference for all purposes as if fully set forth herein.

### BACKGROUND

Field of the Present Disclosure

The present disclosure relates a smart home system, and, more particularly to a smart home system to detect outdoor and indoor environmental factors, to analyze the detected factors, and to vary indoor environmental reference data based on the analysis, and to control indoor home facilities based on the varied reference data so as to reach optimal indoor environmental factors.

Discussion of the Related Art

Generally, in a smart home system, a variety of home-related articles including a home appliance such as a TV, refrigerator, air-conditioner, etc., energy consuming facilities such as a water, electric, lighting, heating/cooling facilities, a security device such as a door lock, surveillance camera, etc. are connected to communication networks, and are monitored and controlled in operations and current states thereof in a remote or automatic way.

Human well-being related industries are rapidly evolving recently including a medical or comfort engineering. Further, fusion technologies between fields of information and communication and medical engineering and home security, and like are rapidly evolving.

Thus, a conventional smart home system may be poor at managing such human well-being related articles and fusion technologies related articles comprehensively.

Recently, as persons reside indoors for longer times, techniques and articles for a human oriented indoor environment have been paid attention for. Further, as a variety of devices for controlling an indoor environment such as a temperature, humidity, air-purification, etc. are disposed indoors at distributed locations, there may be a need for a home smart system for managing such indoor environmental factors comprehensively.

In countries with clearly-distinct four seasons, heating and cooling facilities both are used indoors. In addition to this, an indoor air conditioning product for a fresh and comfortable indoor environment is used indoors, such as a negative ion generator, sterilizer, a dehumidifier, etc. Thus, in order to obtain the fresh and comfortable indoor environment, it may be inconvenient for a user to adjust such above products individually. Thus, there is a need for a smart home system to manage the above products automatically to obtain an optimal indoor environment. Further, a conventional smart home system controls indoor environmental factors without considerations of outdoor environmental factors. Thus, the conventional smart home system may be poorly adapted to environmental changes such as differences between indoor and outdoor temperatures and/or humidity. This may lead to dust, or germs indoors and air-conditioningitis, cough, etc.

In this connection, in order to cope with the above problems resulting from the temperatures and/or humidity differences, in summer, 24° C. to 28° C. of an indoor temperature, and 60% of an indoor humidity should be kept indoors; in spring and fall, 19° C. to 23° C. of an indoor temperature, and 50% of an indoor humidity should be kept indoors; and in winter, 18° C. to 20° C. of an indoor temperature, and 40% of an indoor humidity should be kept indoors.

Korean patent number 10-0432726 B discloses a smart home system configured to control indoor environment factors, medical measurement devices, and health-related devices. To be specific, the disclosed smart home system includes a plurality of network sensors divided functionally and spatially, a core access network to collect data from the sensors, a central control server to receive from the core access network indoor environmental factors such as temperatures, ventilations, and luminance of each indoor space, a database to store therein the collected environmental data, and a controller configured to control indoor environmental factors such as temperatures, ventilations, and luminance of each indoor space. The medical measurement devices may measure a blood pressure, blood-sugar level, etc. The health-related devices may include a bath, massage machine, etc.

However, the disclosed smart home system may apply only a single indoor environmental reference value or may apply a reference value only to a single device. Further, the smart home system may not be adapted to an outdoor environmental change. The smart home system may not apply varying indoor environmental reference values based on the outdoor environmental changes. Further, the smart home system may control a variety of home facilities individually, and thus may be less oriented on a human being and may not be comprehensive.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY

Form considerations of the above situations, the present disclosure provides a smart home system including an outdoor environment sensing sub-system and an indoor environment sensing sub-system detecting outdoor and indoor environmental factors respectively and a controller configured to analyze the detected factors and to vary indoor environmental reference data based on the analysis, and to control indoor home facilities based on the varied reference data so as to reach optimal indoor environmental factors. Further, the present disclosure provides a smart home system to allow reduction of energy consumptions of the home facilities. Further, the present disclosure provides a smart home system to be reliably responsible for an indoor emergency event.

In an aspect of the present disclosure, there is provided a smart home system adapted to indoor and outdoor environmental changes, the system comprising: an outdoor environment sensing sub-system configured to collectively sense outdoor environment factors, wherein the outdoor environment sensing sub-system includes outdoor sensors for sensing the outdoor environment factors, and an outdoor wireless sensor network; an indoor environment sensing sub-system configured to collectively sense indoor environment factors, wherein the indoor environment sensing sub-system includes indoor sensors for sensing the indoor environment factors, and an indoor wireless sensor network; a database configured to receive and store therein the indoor and outdoor environmental factors from the outdoor environment sensing sub-system and indoor environment sensing sub-system respectively, the database being further configured to store therein a preset S/W algorithm; and a controller configured to analyze the indoor and outdoor environmental factors using the S/W algorithm, and to vary reference data for the indoor environmental factors based on the analysis, and to automatically control indoor home facilities based on the varied reference data so as to reach optimal indoor environmental factors.

In one embodiment, the system may further comprise an emergency detection sub-system disposed indoors, wherein the emergency detection sub-system is configured to detect an emergency event in a non-contact manner and send the detected event to the controller.

In one embodiment, the emergency event may include an unhealthy state, damage, or faint of a person resided indoors, and/or a fire, housebreaking, or stealing event.

In one embodiment, the system may comprise an emergency alert module configured to alert the emergency event based on an alert single from the emergency detection sub-system.

In one embodiment, the system may further comprise a power distributor configured to supply a power to the home facilities.

In one embodiment, the power distributor may be configured to receive the power from a commercial power source and/or a self-generated power source, and distribute the power to the home facilities, wherein the distribution is performed in a normal or emergency mode.

In one embodiment, the controller may be configured to enable the indoor environment sensing sub-system to detect energy consumptions of the indoor home facilities.

In one embodiment, the system may further comprise a data transmission module configured to send the energy consumptions to a mobile device of a user.

In one embodiment, the indoor and outdoor wireless sensor network may employ a RFID (radio frequency identification), ZigBee, Wi-Fi, or Bluetooth.

In one embodiment, the emergency detection sub-system may include an infrared sensor, heartbeat sensor, or sound sensor.

In accordance with the present disclosure, the smart home system may automatically control the home facilities based on the varying outdoor and indoor environmental factors to create an optimal indoor environment. Further, the smart home system may respond to an indoor emergency event rapidly and reliably.

Furthermore, the smart home system may allow the user to perceive the indoor energy consumptions and allow the reduction of energy consumptions of the home facilities.

### BRIEF DESCRIPTIONS OF THE DRAWINGS

The accompanying drawings included to provide a further understanding of the present disclosure illustrate embodiments of the present disclosure.

FIG. 1 illustrates a block diagram of a smart home system adapted to indoor and outdoor environmental changes in accordance with the present disclosure.

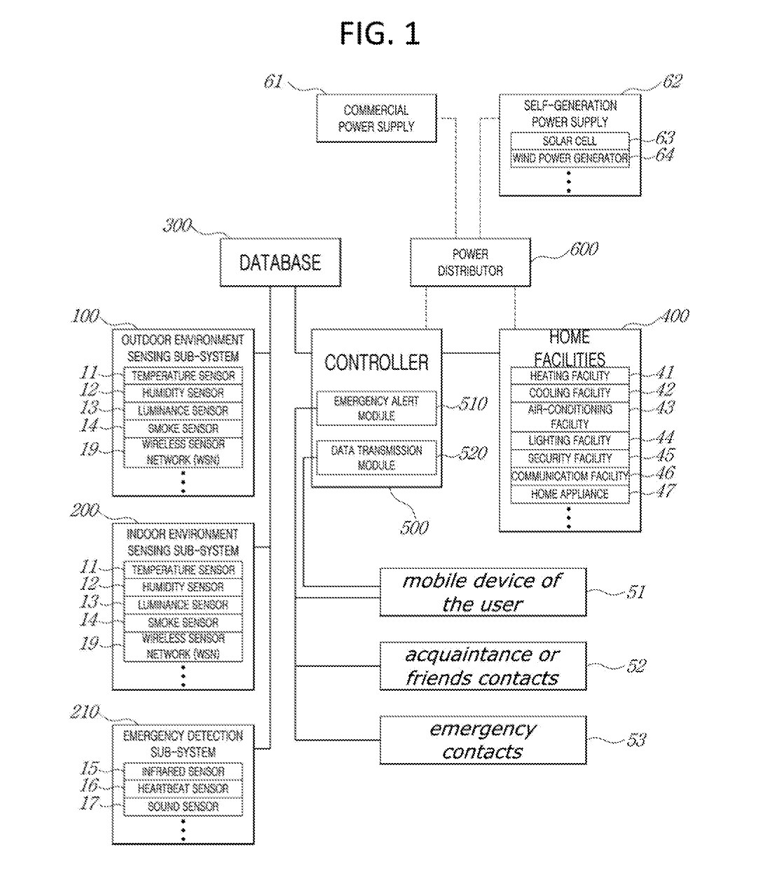

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items.

Expression such as “at least one of” when preceding a list of elements may modify the entire list of elements and may not modify the individual elements of the list.

Spatially relative terms, such as “beneath,” “below,” “lower,” “under,” “above,” “upper,” and the like, may be used herein for ease of explanation to describe one element or feature's relationship to another element s or feature s as illustrated in the FIGURES. It will be understood that the spatially relative terms are intended to encompass different orientations of the device in use or in operation, in addition to the orientation depicted in the FIGURES. For example, if the device in the FIGURES is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

Hereinafter, embodiments of the present disclosure will be described in details with reference to attached drawings.

A smart home system adapted to indoor and outdoor environmental changes in accordance with the present disclosure includes an outdoor environment sensing sub-system 100 disposed outdoors. The sub-system 100 may include a variety of sensors such as a temperature sensor 11, humidity sensor 12, luminance sensor 13, smoke sensor 14, etc. and a wireless sensor network (WSN) 19 using a RFID (radio frequency identification), ZigBee, Wi-Fi, Bluetooth, etc. The outdoor environment sensing sub-system 100 may be configured to collectively sense outdoor environmental factors.

The smart home system includes an indoor environment sensing sub-system 200 disposed indoors. The sub-system 200 may include a variety of sensors such as a temperature sensor 11, humidity sensor 12, luminance sensor 13, smoke sensor 14, etc. and a wireless sensor network (WSN) 19 using a RFID (radio frequency identification), ZigBee, Wi-Fi, Bluetooth, etc. The indoor environment sensing sub-system 200 may be configured to collectively sense indoor environmental factors.

The smart home system includes a database 300 disposed indoors. The database 300 may receive sensed environmental factors from the outdoor environment sensing sub-system 100 and indoor environment sensing sub-system 200 and may store the factors therein. The database 300 may store therein preset S/W algorithms.

The smart home system includes controller 500 configured to analyze the environmental factors from the outdoor environment sensing sub-system 100 and indoor environment sensing sub-system 200 using the S/W algorithm. The controller 500 may be further configured to vary reference data for indoor environmental factors based on the analysis, and to automatically control home facilities 400 based on the varied reference data to reach optimal indoor environmental factors. The home facilities 400 may include a heating facility 41, cooling facility 42, air-conditioning facility 43, lighting facility 44, security facility 45, communication facility 46, home appliance 47, etc. by way of example. The present disclosure is not limited thereto.

The smart home system may further include an emergency detection sub-system 210 disposed indoors. The emergency detection sub-system 210 may detect an emergency event in a non-contact manner and send the detected event to the controller 500. The emergency event may include a unhealthy state, damage, faint, etc. of persons resided indoors, and/or a fire, housebreaking, stealing event, etc. The emergency detection sub-system 210 may include an infrared sensor 15, heartbeat sensor 16, sound sensor 17, etc. by way of example. The present disclosure is not limited thereto.

The controller 500 may further include an emergency alert module 510 configured to alert the emergency event based on an alert single from the emergency detection sub-system 210. This alerting may be achieved by calling an emergency contact number pre-stored in the database 300. In an alternative, the emergency alert module 510 may not be incorporated in the controller.

The smart home system may further include a power distributor 600 to supply the power to the home facilities 400. The power distributor may receive the power from a commercial power source 61 and/or a self-generated power source 63 such as a solar cell 63, a wind power generator 64, etc. and distribute the power to the home facilities 400. The distribution may be performed in a normal or emergency mode.

The controller 500 may be configured to enable the indoor environment sensing sub-system 200 to detect energy consumptions of the indoor home facilities 400. The controller 500 may further include a data transmission module 520 configured to send energy consumptions detected by the indoor environment sensing sub-system 200 to a mobile device of a user. The energy consumptions may include electrical, LNG gas, water consumptions, etc.

Hereinafter, the above components in the smart home system in accordance with present disclosure will be more specifically described.

The sensors in the outdoor environment sensing sub-system 100 disposed outdoors are as follows: the outdoor temperature sensor 11 may detect an outdoor temperature; the outdoor humidity sensor 12 may detect an outdoor humidity; the outdoor luminance sensor 13 may detect an outdoor luminance; and the outdoor smoke sensor 14 may detect an outdoor a smoke or dust or a pollution level, etc. The present disclosure is not limited thereto. Another outdoor sensor(s) may be included in the outdoor environment sensing sub-system 100 to detect another outdoor environmental factor(s).

The outdoor environment sensing sub-system 100 may communicate with the controller 500 and the database 300 using the outdoor wireless sensor network 19. The wireless sensor network 19 may be implemented in the RFID (radio frequency identification), ZigBee, Wi-Fi, Bluetooth, etc. The wireless sensor network 19 may be connected to an outdoor surveillance camera (CCTV) to detect a movement of a car and/or a person.

The sensors in the indoor environment sensing sub-system 200 disposed indoors are as follows: the indoor temperature sensor 11 may detect an indoor temperature; the indoor humidity sensor 12 may detect an indoor humidity; the indoor luminance sensor 13 may detect an indoor luminance; and the indoor smoke sensor 14 may detect an indoor a smoke or dust or a pollution level, etc. The present disclosure is not limited thereto. Another indoor sensor(s) may be included in the indoor environment sensing sub-system 200 to detect another indoor environmental factor(s).

The indoor environment sensing sub-system 100 may communicate with the controller 500 and the database 300 using the indoor wireless sensor network 19. The indoor wireless sensor network 19 may be implemented in the RFID (radio frequency identification), ZigBee, Wi-Fi, Bluetooth, etc. The indoor wireless sensor network 19 may be wirelessly connected to the home appliance 47. The indoor wireless sensor network 19 may be connected to an indoor surveillance camera (CCTV) to detect an indoor movement or presence of a person. In an alternative, the indoor wireless sensor network 19 may be connected to a sensing module to sense the mobile device, smart key or the like to detect an indoor movement or presence of a person.

The controller 500 may be configured to control a power supply and operations of the home facilities 400 such as the heating facility 41, cooling facility 42, air-conditioning facility 43, lighting facility 44, security facility 45, communication facility 46, home appliance 47, etc. To this end, the controller 500 may incorporate an IoT (Internet of things) technique. In the IoT technique, various articles such as a home appliance, healthcare device, remote metering device, smart car, home facility, etc. may be connected to a network to allow information share and communication.

In this connection, the controller 500 may be configured to analyze the detected indoor and outdoor environmental factors from the indoor environment sensing sub-system 200 and outdoor environment sensing sub-system 100 using the S/W algorithm stored in the database 300, and, then, to automatically adjust the indoor environmental reference data.

To be specific, the controller 500 may be configured to analyze indoor environmental factors related to persons, instruments, animals, plants, home appliance, etc. resided indoors together with the detected outdoor environmental factors using the algorithm, and to store the analysis into the database 300. At the same time, the controller 500 may be configured to determine the indoor environmental reference data based on the analysis, and to control the above facilities to reach the optimal temperature, humidity, luminance, etc.

In order to reach the optimal the indoor environmental factors, when the optimal factors do not reach at a first adjustment, a second, third, and so on adjustment may be performed in a repeated manner.

The controller 500 may be configured to create a S/W algorithm programmed to determine the indoor environmental reference data using the indoor environmental factors comprehensively, and to store the S/W algorithm into the database 300. The controller 500 may be configured to repetitively adjust environmental parameters related to the above facilities to reach the optimal indoor environmental factors.

For example, using the smart home system, an indoor temperature, humidity, brightness, a stealing-prevention, fire-preventing, heater, TV, air-conditioner, robot, cleaner, furniture, renewable energy such as solar, wind, geo-thermal energy, vehicle, neck state check, medical service, auto drive, message, instructions, or the like may be automatically controlled in an intellectual fashion.

The present smart home system, in particular, the controller may be configured to automatically determine indoor environmental reference data including indoor temperature, humidity, luminance, pollution, etc. and to control an air-conditioner, a humidifier, a boiler, an air purification device, an illumination device, etc. selectively or in a combination thereof based on the indoor environmental reference data to reach target indoor environmental factors such as the indoor temperature, humidity, luminance, pollution, etc.

The controller 500 may include a timer and thus may be configured to control operations of the home facilities 400 such as an air-conditioner, a humidifier, a boiler, an air purification device, an illumination device, TV, a security system, a computer, a washing machine, etc. based on timing data.

The controller 500 may be configured to control a robot cleaner located indoors to clear indoor spaces based on indoor reference data.

The emergency detection sub-system 210 may include a biometric sensor to sense biometric information such as a blood pressure, temperature, blood sugar level, etc. of a person residing indoors, and an automatic message sending device to call a pre-registered contact number and sending a pre-programmed voice message. Further, biometric reference data may be pre-stored in the database in order to determine an abnormal state of the person residing indoors. In this connection, when the biometric information detected via the biometric sensor exceeds the biometric reference data, the controller 500 may be configured to enable the emergency alert module 510 to send a pre-programmed emergency message to a guardian, a 119 service, a policeman, etc. This may be useful for an old man living alone, or a patient, or the like.

The skilled person to the art may appreciated that, although not shown in the FIGURE, the emergency detection sub-system 210 may be configured to receive biometric information such as a heartbeat, a blood-pressure, a blood sugar level, etc. from a smart phone or a smart watch of the user and then send the biometric information to the controller 500 in a wireless manner. This may allow free indoor activities of the user.

The present smart home system may further include metric sensors for metering energy consumption levels of electric, water, LNG, another energy consuming facilities, etc. and the data transmission module 520 configured to automatically call contact numbers of the electric, water, LNG, and/or another energy suppliers and to send the detected energy consumption levels thereto. The present smart home system may be further configured to meter the energy consumption levels and to enable the data transmission module 520 to send the detected energy consumption levels to the mobile device 51 of the user. Thus, the user may immediately check the energy consumption levels without waiting for a specific metering day.

In this connection, the user may enable the mobile device 51 thereof to send call contact numbers of the electric, water, LNG, and/or another energy suppliers, and to send the received energy consumption levels thereto, and to pay for the various energy costs using a credit card, web-card, mobile payment, or account transfer payment system, etc.

The present smart home system may further include the smoke sensor 14 configured to detect a smoke together with the temperature sensor 11. In this connection, reference data for temperature and smoke levels indicating the fire event may be pre-stored in the database. Thus, when a temperate detected by the temperature sensor 11 and/or a smoke level detected by the smoke sensor 14 exceeds the reference data, the controller 500 may be configured to enable the emergency alert module 510 to inform emergency contacts 53 such as a pre-registered person, 119 service, policeman, etc. or acquaintance or friends contacts of a message or alert signal indicating the fire event. Thus, although a person does not reside indoors, the fire event may be coped with rapidly.

The present smart home system may further include the commercial power supply 61 and the self-generation power supply 62 including a solar cell device 63, a wind power generator 64, etc. in order to supply the power to the variety of the indoor and outdoor sensors, and the variety of the home facilities 400. In this connection, the controller 500 may be configured to enable the self-generation power supply 62 rather than the commercial power supply 61 to supply the power to the variety of the indoor and outdoor sensors, and the variety of the home facilities 400. This may lead to minimized consumption of the commercial power supply 61.

In the above descriptions, the present smart home system is applied to measure and analyze the power consumption, temperature, humidity, luminance, pollution level, biometric information, variety of energy consumptions including water, electric, LNG or the like, smoke level, etc. and then to control the air-conditioner, humidifier, boiler, air purification device, lighting device, TV, security system, computer, washing machine, robot cleaner, etc. However, the present disclosure is not limited thereto. For example, the present smart home system may include sensors for detecting oxygen and/or carbon dioxide levels, and may automatically control an oxygen generator. Further, the present smart home system may include indoor and outdoor cameras to monitor indoor and outdoor environments, and thus may control the variety of the sensors and home facilities in a supplementing manner depending on the monitored results.

In the above descriptions, the present smart home system is configured such that the variety of the reference or target data is stored in the database. However, the present disclosure is not limited thereto. For example, the database may further include a commutation module configured to communicate with externals, and, thus receive the variety of the reference or target data therefrom. In this connection, the variety of the reference or target data to be sent to the database may be adjusted by the smart phone or another mobile device, or the like of the user. The user may monitor in a real time manner the indoor environmental factors using the smart phone or another mobile device, or the like of the user.

Further, the present disclosure may be applied to an artificial planting such as a flower, vegetable, or tree planting. In this regard, a luminance, temperature, watering, etc. may be automatically controlled to allow a reliable growth of the various plants. To this end, the present smart home system may be configured to control the home facilities to reach optimal environmental factors such as the luminance, temperature, humidity, etc. for the various plants.

Further, the present disclosure may have a livestock application. To be specific, the present smart system may be configured to check health information including a temperature, heartbeat, waste components, etc. of various livestock and to automatically perform an appropriate action based on the detected information. The action may include a feeding, medical treatment, excreta, etc. Further, in an abnormal health event, health information may be sent to the mobile device 51 of the user. This may result in an automatic livestock process.

In accordance with the present disclosure, the smart home system may automatically control the home facilities based on the varying outdoor and indoor environmental factors to create an optimal indoor environment. Further, the smart home system may respond to an indoor emergency event rapidly and reliably. Furthermore, the smart home system may allow the user to perceive the indoor energy consumptions and allow the reduction of energy consumptions of the home facilities.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A smart home system adapted to indoor and outdoor environmental changes, the system comprising:
an outdoor environment sensing sub-system configured to collectively sense outdoor environment factors, wherein the outdoor environment sensing sub-system includes outdoor sensors for sensing the outdoor environment factors, and an outdoor wireless sensor network;
an indoor environment sensing sub-system configured to collectively sense indoor environment factors, wherein the indoor environment sensing sub-system includes indoor sensors for sensing the indoor environment factors, and an indoor wireless sensor network;
a database configured to receive and store therein the indoor and outdoor environmental factors from the outdoor environment sensing sub-system and indoor environment sensing sub-system respectively, the database being further configured to store therein a preset S/W algorithm; and
a controller configured to analyze the indoor and outdoor environmental factors using the S/W algorithm, and to vary reference data for the indoor environmental factors based on the analysis, and to automatically control indoor home facilities based on the varied reference data so as to reach optimal indoor environmental factors.

2. The system of claim 1, further comprising an emergency detection sub-system disposed indoors, wherein the emergency detection sub-system is configured to detect an emergency event in a non-contact manner and send the detected event to the controller.

3. The system of claim 2, wherein the emergency event may include an unhealthy state, damage, or faint of a person resided indoors, and/or a fire, housebreaking, or stealing event.

4. The system of claim 2, wherein the system comprises an emergency alert module configured to alert the emergency event based on an alert single from the emergency detection sub-system 210.

5. The system of claim 1, further comprising a power distributor configured to supply a power to the home facilities.

6. The system of claim 5, wherein the power distributor is configured to receive the power from a commercial power source and/or a self-generated power source, and distribute the power to the home facilities, wherein the distribution is performed in a normal or emergency mode.

7. The system of claim 1, wherein the controller is configured to enable the indoor environment sensing sub-system to detect energy consumptions of the indoor home facilities.

8. The system of claim 7, further comprising a data transmission module configured to send the energy consumptions to a mobile device of a user.

9. The system of claim 1, wherein the indoor and outdoor wireless sensor network employs a RFID (radio frequency identification), ZigBee, Wi-Fi, or Bluetooth.

10. The system of claim 2, wherein the emergency detection sub-system includes an infrared sensor, heartbeat sensor, or sound sensor.
